(19) United States
(12) Patent Application Publication
(10) Pub. No.: US 2017/0036713 A1
(43) Pub. Date: Feb. 9, 2017

(54) FRAME ASSEMBLY FOR MACHINE

(71) Applicant: Caterpillar Global Mining LLC, South Milwaukee, WI (US)

(72) Inventor: Heidi R. Balestrieri, Waukesha, WI (US)

(73) Assignee: Caterpillar Global Mining LLC, South Milwaukee, WI (US)

(21) Appl. No.: 15/332,965

(22) Filed: Oct. 24, 2016

(51) Int. Cl. B62D 55/10; B62D 55/15

(52) U.S. Cl. CPC B62D 55/10; B62D 55/15; E02F 3/308

(57) ABSTRACT

A frame assembly for a machine is disclosed. The frame assembly includes a first frame member having a first surface, a second surface opposite to the first surface, and a third surface defining a first through-hole extending between the first surface and the second surface. The frame assembly further includes a second frame member spaced apart from the first frame member, the second frame member having a first surface, a second surface opposite to the first surface, and a third surface defining a second through-hole extending between the first surface and second surface. The frame assembly further includes a first sleeve member inserted through the first through-hole of the first frame member. The frame assembly further includes a second sleeve member inserted through the second through-hole of the second frame member. The frame assembly further includes a roller unit disposed between the first frame member and the second frame member.

### TECHNICAL FIELD

The present disclosure relates to track-type machines, and more particularly relates to a frame assembly for a track-type machine.

### BACKGROUND

Generally, track-type machines, such as excavators, cranes, and electric rope shovels include a ground engaging assembly to receive power from a power source and propel the track-type machines. The ground engaging assembly typically includes a frame assembly having a first frame wall and a second frame wall opposite to the first frame wall. The first frame wall and the second frame wall include a plurality of apertures and one or more rollers disposed between the first frame wall and the second frame wall. Spacers, such as teardrops, are provided on inner surfaces of each of the first frame wall and the second frame wall to support coupling between a shaft and the one or more rollers. Typically, the teardrops are spacers in the shape of a drop of water. The teardrops are generally large in size and are coupled to the inner surfaces of each of the first frame wall and the second frame wall. In order to couple the teardrops to the inner surfaces of the first frame wall and the second frame wall, welds are provided on the inner surface which often proves to be a time intensive and cumbersome process. In addition, due to continuous operation of the ground engaging assembly, the teardrops get damaged or worn out. Positioning of the teardrops on the inner surfaces also makes servicing and repair of the teardrops difficult and time intensive.

### SUMMARY OF THE DISCLOSURE

In one aspect of the present disclosure, a frame assembly for a machine is provided. The frame assembly includes a first flame member having a first surface, a second surface opposite to the first surface, and a third surface defining a first through-hole extending between the first surface and the second surface. The frame assembly further includes a second frame member spaced apart from the first frame member. The second frame member has a first surface, a second surface opposite to the first surface, and a third surface defining a second through-hole extending between the first surface and second surface. The frame assembly further includes a first sleeve member inserted through the first through-hole of the first frame member. The first sleeve member includes a first flange portion extending from the first surface of the first frame member. The first sleeve member further includes a second flange portion extending from the second surface of the first frame member. The frame assembly further includes a second sleeve member inserted through the second through-hole of the second frame member. The second sleeve member includes a third flange portion extending from the first surface of the second frame member. The second sleeve member further includes a fourth flange portion extending from the second surface of the second frame member. The frame assembly further includes a roller unit disposed between the first frame member and the second frame member. The roller unit includes a shaft and an inner peripheral surface defining a hole aligned with the first through-hole and the second through-hole. The shaft is adapted to be inserted through the first sleeve member, the second sleeve member, and the hole of the roller unit to couple the roller unit with each of the first sleeve member and the second sleeve member.

Other features and aspects of this disclosure will be apparent from the following description and the accompanying drawings.

### BRIEF DESCRIPTION OF THE DRAWINGS

FIG. 1 is a perspective view of a machine having a frame assembly;

FIG. 2 is a perspective view of the frame assembly of the machine of FIG. 1;

FIG. 3 is a perspective view of a portion of the frame assembly of FIG. 2;

FIG. 4 is a top view of the frame assembly of FIGS. 2; and

FIG. 5 is a sectional view of the frame assembly of FIG. 4.

### DETAILED DESCRIPTION

Reference will now be made in detail o specific embodiments or features, examples of which are illustrated in the accompanying drawings. Wherever possible, corresponding or similar reference numbers will be used throughout the drawings to refer to the same or corresponding parts. Moreover, references to various elements described herein, are made collectively or individually when there may be more than one element of the same type. However, such references are merely exemplary in nature. It may be noted that any reference to elements in the singular may also be construed to relate to the plural and vice-versa without limiting the scope of the disclosure to the exact number or type of such elements unless set forth explicitly in the appended claims.

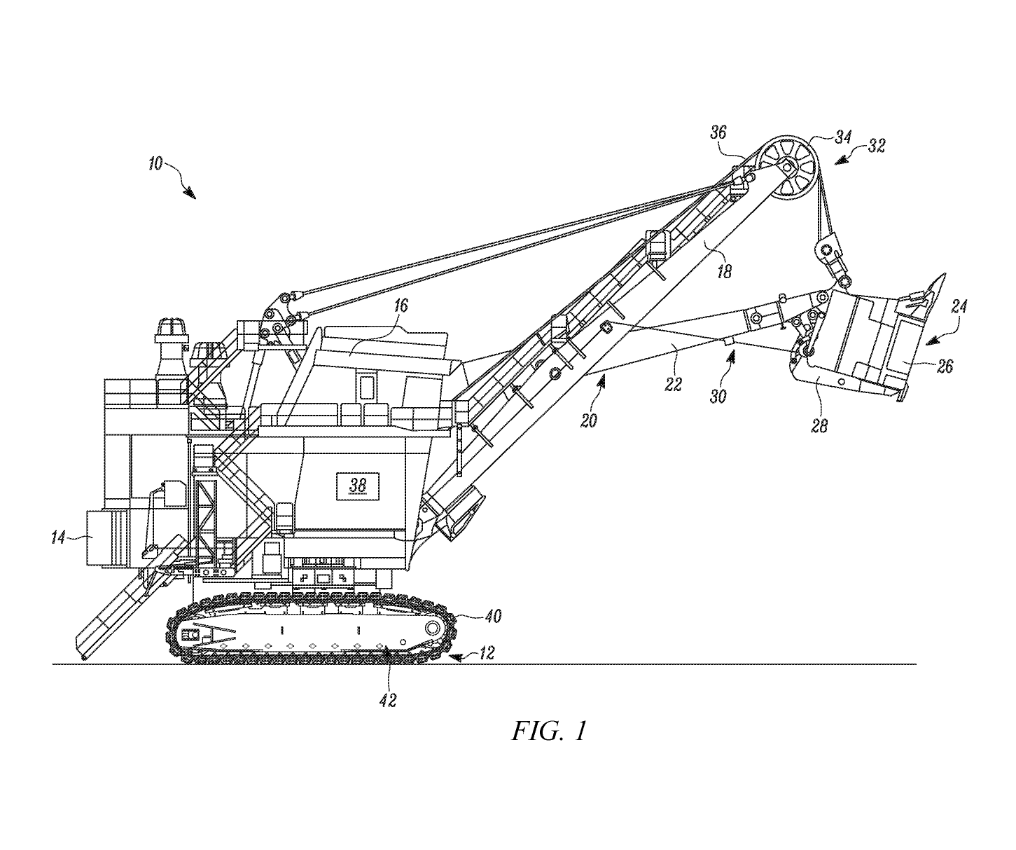

Referring to FIG. 1, a side view of a machine 10 having a around engaging assembly 12 is illustrated. In the illustrated embodiment, the machine 10 is depicted as an electric rope shovel. Although the machine 10 is shown as the electric rope shovel, the machine 10 may embody any other tracked machine associated with mining, agriculture, forestry, construction, and other industrial applications. The machine 10 performs various operations, such as excavation of material at a worksite. The machine 10 includes a frame 14 for providing support to various components of the machine 10, such as an operator cabin 16. The operator cabin 16 includes an operator interface (not shown), which may include one or more input devices not shown), such as an accelerator, a braking pedal, a steering, and a display device.

The machine 10 includes a boom 18 operably coupled to the frame 14. The machine 10 further includes a crowd mechanism 20 extending from the boom 18. The crowd mechanism 20 includes a handle 22 and a dipper 24 coupled to the handle 22. In the illustrated embodiment, the dipper 24 acts as the implement of the machine 10. However, in an example, the implement may be a bucket. The handle 22 is adapted to slidably move with respect to the boom 18. Owing to the sliding movement of the handle 22, the crowd mechanism 20 extends or retracts the dipper 24. In an example, the crowd mechanism 20 may extend or retract the dipper 24 by any known methods including, but not limited to, a pneumatic arrangement, a hydraulic arrangement or a cable arrangement. The dipper 24 of the machine 10 includes a body 26 and a door 28 pivotally coupled to the body 26. The dipper 24 dumps the material based on an operation of the door 28. The machine 10 further includes a dipper trip mechanism 30 coupled to the door 28 of the dipper 24. The dipper trip mechanism 30 operates the door 28 of the dipper 24. Further, the dipper 24 is raised or lowered by a hoist mechanism 32. The hoist mechanism 32 is provided on the boom 18. The hoist mechanism 32 includes a winch (not shown), a pulley 34 and a hoist cable 36. The hoist cable 36 is connected to the winch at one end. The hoist cable 36 extends over the pulley 34 and is connected to the dipper 24 at the other end. Based on a rotation of the winch, the hoist cable 36 retracts or extends relative to the winch.

The machine 10 further includes a power source 38 mounted on the frame 14. The power source 38 may be any power source including, but not limited to, an internal combustion engine, an electric motor and so on, or a combination thereof. The power source 38 provides power to the machine 10 for operational and mobility requirements. Further, for mobility requirements of the machine 10, the ground engaging assembly 12 receives the power output from the power source 38. The ground engaging assembly 12 includes a track 40 and a frame assembly 42. The track 40 receives the power output from the power source 38 via, a transmission assembly (not shown). The track 40 forms a continuous structure operatively coupled to multiple rollers 44 of the frame assembly 42. The frame assembly 42 supports the multiple rollers 44 to improve traction of the track 40 on a surface.

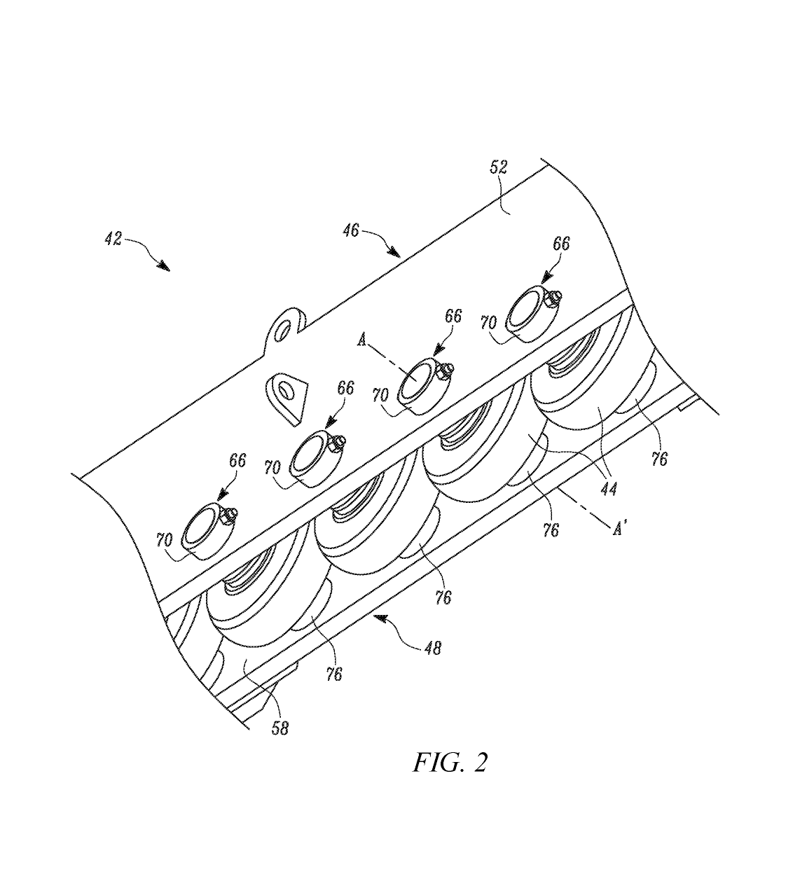

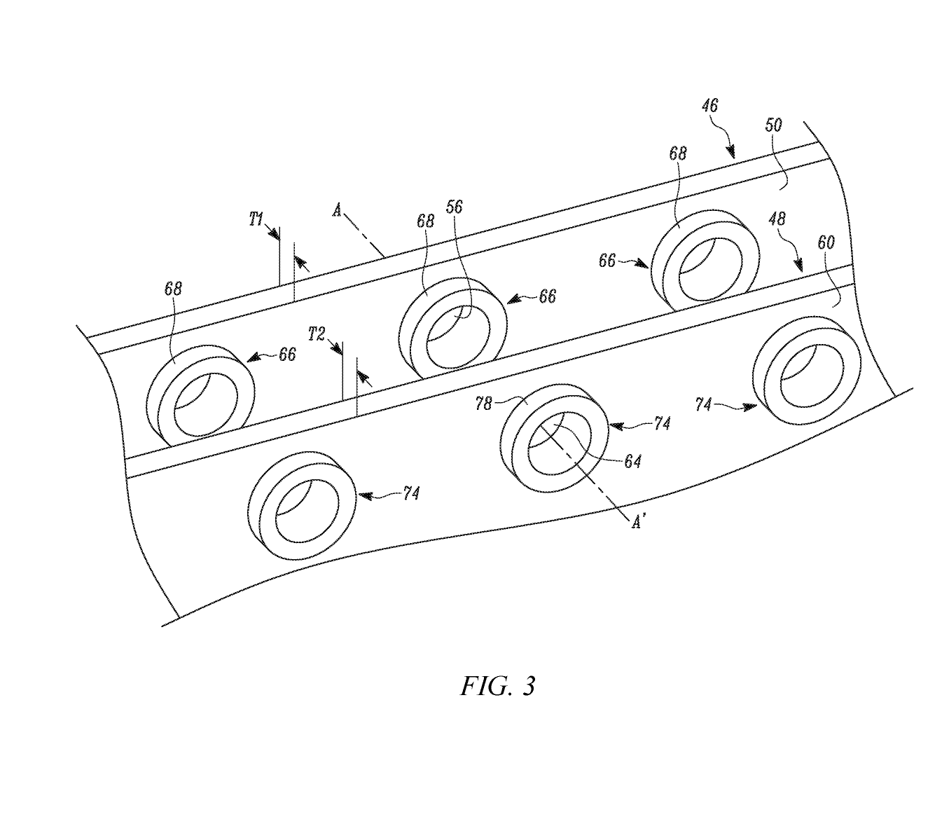

Referring to FIG. 2 and FIG. 3, a portion of the frame assembly 42 is illustrated. The frame assembly 42 includes a first frame member 46 and a second frame member 48. Likewise, a frame assembly (not illustrated) on other side of the machine 10 may also include a first frame member (not illustrated) and a second frame member (not illustrated) similar to the first frame member 46 and the second frame member 48, respectively, of the frame assembly 42. The second frame member 48 is spaced apart from the first frame member 46, as depicted in the FIG. 2 and FIG. 3. Although, the frame assembly 42 includes multiple shafts and rollers, it would be appreciated that the present disclosure is explained with respect to a shaft and a roller of the frame assembly 42.

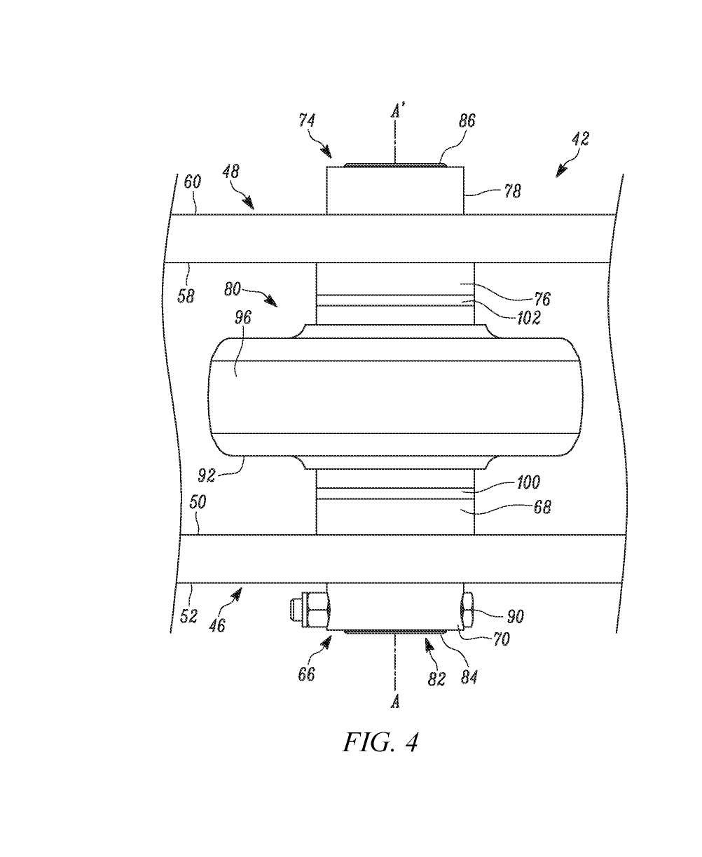

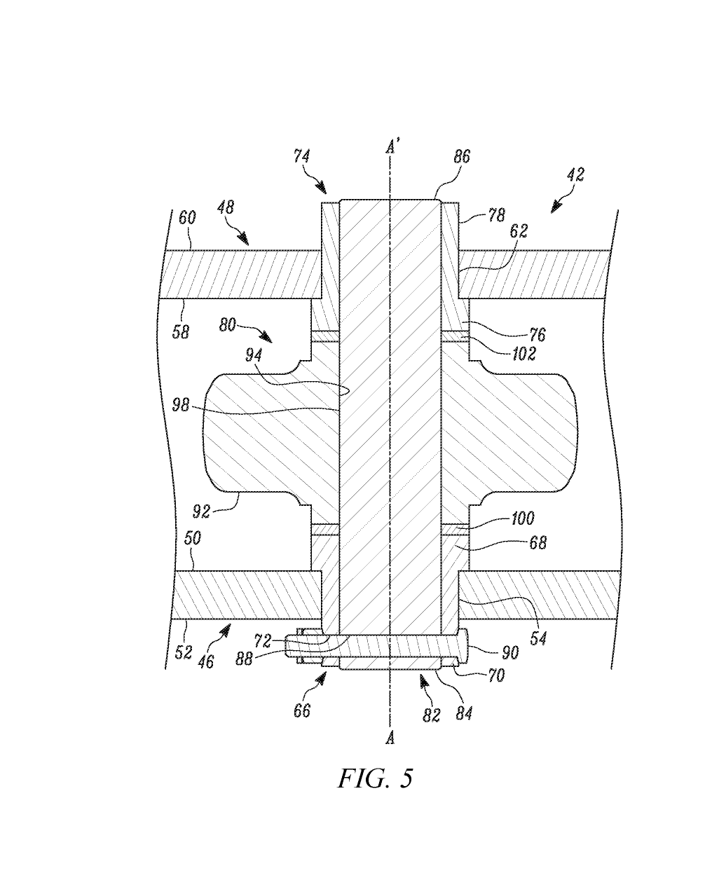

The first frame member 46 includes a first surface 50 and a second surface 52 (as shown in FIG. 4) opposite to the first surface 50 defining a thickness ‘T1’. More specifically, the first surface 50 forms an inner surface of the frame assembly 42 and the second surface 52 forms an outer surface of the frame assembly 42. The first frame member 46 further includes a third surface 54 (shown in FIG. 5) defining a first through-hole 56 extending between the first surface 50 and the second surface 52. The second frame member 48 includes a first surface 58 and a second surface 60 opposite to the first surface 58 defining a thickness ‘T2’. More specifically, the first surface 58 forms the inner surface of the frame assembly 42 and the second surface 60 forms the outer surface of the frame assembly 42. The second frame member 48 further includes a third surface 62 (shown in FIG. 5) defining a second through-hole 64 extending between the first surface 58 and the second surface 60. In an example, the first through-hole 56 and the second through-hole 64 may be circular in shape and accordingly, the first through-hole 56 of the first frame member 46 has an inner diameter ‘D1’ and the second through-hole 64 of the second frame member 48 has an inner diameter ‘D2’. As such, the inner diameter ‘D1’ of the first through-hole 56 and the inner diameter ‘D2’ of the second through-hole 64 are dimensionally equal. In various other examples, the first through-hole 56 and the second through-hole 64 may assume a shape such as oval, rectangular, hexagonal, or any other shape known in the art. Further, the first through-hole 56 and the second through-hole 64 are inline with each other to form a coaxial pair of through-holes about an axis A-A′. Although, the present disclosure is explained only with respect to the first through-hole 56 and the second through-hole 64, it would be appreciated that the first frame member 46 and the second frame member 48 may include multiple pairs of through-holes, such as the first through-hole 56 and the second through-hole 64.

The frame assembly 42 further includes a first sleeve member 66 inserted through the first through-hole 56 of the first frame member 46 as shown in FIG. 3. The first sleeve member 66 forms an interference fit with the first through-hole 56. In an example, the interference fit may be one of, but not limited to, a press fit, a tight fit, and any other type of interference fit known in the art. The first sleeve member 66 and the first through-hole 56 have an identical cross-section. In the illustrated embodiment, the first sleeve member 66 and the first through-hole 56 have a circular cross-section. The first sleeve member 66 has an outer diameter ‘D3’. The inner diameter ‘D1’ of the first through-hole 56 is greater than the outer diameter ‘D3’ of the first sleeve member 66. The first sleeve member 66 includes a first flange portion 68 extending from the first surface 50 of the first frame member 46. In an example, the first flange portion 68 may be a protrusion from the first surface 50 of the first frame member 46. More specifically, the first flange portion 68 extends inwards along the axis A-A′ to act as spacer, as shown in FIG. 2. The first sleeve member 66 further includes a second flange portion 70 extending from the second surface 52 of the first frame member 46. In an example, the second flange portion 70 may be a protrusion from the second surface 52 of the first frame member 46. More specifically, the second flange portion 70 extends outwards from the second surface 52 of the first frame member 46 along the axis A-A′. The second flange portion 70 further includes a through-hole 72 (as shown in FIG. 5). Further, the second flange portion 70 is welded to the second surface 52 of the first frame member 46 along a periphery of the first through-hole 56.

Further, the flume assembly 42 includes a second sleeve member 74 inserted through the second through-hole 64 of the second frame member 48 as shown in FIG. 3. The second sleeve member 74 forms interference fit with the second through-hole 64. In an example, the interference fit may be one of, but not limited to, a press fit, a tight fit, and any other type of interference fit known in the art. The second sleeve member 74 and the second through-hole 64 have an identical cross-section. In the illustrated embodiment, the second sleeve member 74 and the second through-hole 64 have a circular cross-section. The second sleeve member 74 has an outer diameter ‘D4’. The inner diameter ‘D2’ of the second through-hole 64 is greater than the outer diameter ‘D4’ of the second sleeve member 74. The second sleeve member 74 includes a third flange portion 76 extending from the first surface 58 of the second frame member 48. In an example, the third flange portion 76 may be a protrusion from the first surface 58 of the second frame member 48. More specifically, the third flange portion 76 extends inwards along the axis A-A′ to act as spacer. The second sleeve member 74 further includes a fourth flange portion 78 extending from the second surface 60 of the second frame member 48. In an example, the fourth flange portion 78 may be a protrusion from the second surface 60 of the second frame member 48. More specifically, the fourth flange portion 78 extends outwards from the second surface 60 of the second frame member 48 along the axis A-A′. Further, the fourth flange portion 78 is welded to the second surface 60 of the second frame member 48 along a periphery of the second through-hole 64. Although, the present disclosure is explained only with respect to the first sleeve member 66 and the second sleeve member 74, it would be appreciated that the frame assembly 42 may include multiple sleeve members corresponding to the number of through-holes.

Referring to FIG. 4 and FIG. 5, a top view, and a sectional view of the frame assembly 42, respectively, is illustrated. The frame assembly 42 includes a roller unit 80 disposed between the first frame member 46 and the second frame member 48. The roller unit 80 includes a shaft 82. In an example, the shaft 82 may be a cylindrical rod coupled to the first frame member 46 and the second frame member 48. The shaft 82 includes a first end 84 and a second end 86. The first end 84 of the shaft 82 passes through the first through-hole 56 of the first frame member 46 and the second end 86 passes through the second through-hole 64 of the second frame member 48. Further, the shaft 82 is inserted along the axis A-A′ through the first through-hole 56 of the first frame member 46 and the second through-hole 64 of the second frame member 48. The first sleeve member 66 and the second sleeve member 74 aids in securing the shaft 82 to the first frame member 46 and the second frame member 48, respectively. The first end 84 of the shaft 82 has an aperture 88 to receive a fastening member 90, such as a bolt, to couple the shaft 82 with the first frame member 46 and the second frame member 48. The fastening member 90 restricts movement of the shaft 82 along the axis A-A′. The roller unit 80 further includes a roller 92 mounted on the shaft 82. The roller 92 has an inner peripheral surface 94 and an outer peripheral surface 96. An inner diameter ‘D5’ of the roller 92 defines the inner peripheral surface 94. Further, the inner peripheral surface 94 defines a hole 98 aligned with the first through-hole 56 and the second through-hole 64. The hole 98 of the roller 92 is aligned with the first through-hole 56 of the first frame member 46 and the second through-hole 64 of the second frame member 48 to receive the shaft 82. In particular, the roller unit 80 couples the shaft 82 with each of the first sleeve member 66 and the second sleeve member 74. Further, a first washer 100 is disposed between the roller 92 and the first flange portion 68 of the first sleeve member 66 and a second washer 102 is disposed between the roller 92 and the third flange portion 76 of the second sleeve member 74. The first washer 100 and the second washer 102 restrict movement of the shaft 82 along the axis A-A′.

During assembly, the first through-hole 56 of the first frame member 46 and the second through-hole 64 of the second frame member 48 inline with the first through-hole 56 receive the first sleeve member 66 and the second sleeve member 74 therethrough, respectively. Due to difference in the inner diameter ‘D1’ of the first through-hole 56 and the outer diameter ‘D3’ of the first sleeve member 66 and inner diameter ‘D2’ of the second through-hole 64 and the outer diameter ‘D4’ of the second sleeve member 74, the first sleeve member 66 and the second sleeve member 74 are received within the first through-hole 56 and the second through-hole 64 through interference fit. In an example, the first sleeve member 66 and the second sleeve member 74 with initial outer diameters are diametrically contracted, by cooling or freezing. Due to such cooling, the outer diameter ‘D3’ of the first sleeve member 66 becomes less than the inner diameter ‘D1’ of the first through-hole 56, and the outer diameter of the second sleeve member 74 ‘D4’ becomes less than the inner diameter ‘D2’ of the second through-hole 64. The first sleeve member 66 is inserted in the first through-hole 56 and the second sleeve member 74 is inserted in the second through-hole 64. Further, the roller 92 is placed between the first frame member 46 and the second frame member 48 of the frame assembly 42. More specifically, the hole 98 of the roller 92 is aligned with respect to the first through-hole 56 of the first frame member 46 and the second through-hole 64 of the second frame member 48. In such an aligned condition of the hole 98 with the first through-hole 56 and the second through-hole 64, the shaft 82 is received therethrough. When the shaft 82 is received within the first through-hole 56 and the second through-hole 64, the aperture 88 of the shaft 82 is aligned with respect to the through-hole 72 of the second flange portion 70. In order to retain the shaft 82 within the first through-hole 56 and the second through-hole 64, the fastening member 90 is inserted through the aperture 88 of the shaft 82 and the through-hole 72 of the second flange portion 70. Further, the first flange portion 68 acts as a spacer between the first surface 50 of the first frame member 46 and the outer peripheral surface 96 of the roller 92 and similarly, the third flange portion 76 acts as a spacer between the first surface 58 of the second frame member 48 and the outer peripheral surface 96 of the roller 92.

### INDUSTRIAL APPLICABILITY

The present disclosure relates to the frame assembly 42 for the machine 10. The frame assembly 42 includes the first sleeve member 66 and the second sleeve member 74. The first sleeve member 66 and the second sleeve member 74 are pre-machined components that are welded to the frame assembly 42 from outside, thereby reducing welding time, machining time, and cost of manufacturing the first sleeve member 66 and the second sleeve member 74. More specifically, the second flange portion 70 of the first sleeve member 66 is welded to the second surface 52 of the first frame member 46, thereby ensuring welds on the second surface 52 which is on the outer surface of the first frame member 46. Therefore welds on the inner surface of the first frame member 46 are eliminated., and thus formation of the frame assembly 42 takes less time, and is easy. In addition, the replacement and servicing of the first sleeve member 66 and the second sleeve member 74 is simplified, because of presence of welds on the outer surface. Further, the first sleeve member 66 and the second sleeve member 74 are easily replaceable upon wear and tear. Further, the shaft 82 is secured to the first frame member 46 by the fastening member 90 present between the shaft 82 and the second flange portion 70. Therefore, a requirement of an additional weld between the shaft 82 and the second flange portion 70 for retention of the shaft 82 is also prevented.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A frame assembly for a machine, the frame assembly comprising:
a first frame member having a first surface, a second surface opposite to the first surface, and a third surface defining a first through-hole extending between the first surface and the second surface;
a second frame member spaced apart from the first frame member, the second frame member having a first surface, a second surface opposite to the first surface, and a third surface defining a second through-hole extending between the first surface and the second surface;
a first sleeve member inserted through the first through-hole of the first frame member, the first sleeve member includes a first flange portion extending from the first surface of the first frame member, and a second flange portion extending from the second surface of the first frame member;
a second sleeve member inserted through the second through-hole of the second frame member, the second sleeve member includes a third flange portion extending from the first surface of the second frame member and a fourth flange portion extending from the second surface of the second frame member; and
a roller unit disposed between the first frame member and the second frame member, wherein the roller unit includes a shaft and an inner peripheral surface defining a hole aligned with the first through-hole and the second through-hole, the shaft adapted to be inserted through the first sleeve member, the second sleeve member, and the hole of the roller unit to couple the roller unit with each of the first sleeve member and the second sleeve member.
